(19) United States
(12) Patent Application Publication
(10) Pub. No.: US 2012/0305487 A1
(43) Pub. Date: Dec. 6, 2012

(54) Method for Treating Anemia in Hemodialysis Patients

(75) Inventors: Werner Beck, Rottenburg (DE); Juan Bosch, Washington, DC (US)

(73) Assignee: Gambro Lundia AB, Lund (SE)

(21) Appl. No.: 13/477,473

(22) Filed: May 22, 2012

Related U.S. Application Data
(60) Provisional application No. 61/491,400, filed on May 31, 2011.

(51) Int. Cl. B01D 71/06; B01D 61/24

(52) U.S. Cl. 210/647; 210/646; 210/500.27

(57) ABSTRACT

The present invention relates to a method of treating anemia especially in an EPO resistant hemodialysis patient, comprising hemodialysis with a high cut-off dialysis membrane, wherein the hemodialysis membrane is characterized in that it has a molecular weight cut-off in water, based on dextran sieving coefficients, of between 90 and 200 kD and a molecular weight retention onset in water, based on dextran sieving coefficients, of between 10 and 20 kD, and a ΔMW of between 90 and 170 kD. The invention further relates to a high cut-off hemodialysis membrane for the treatment of anemia in hemodialysis patients, especially EPO resistant hemodialysis patients.

### CROSS REFERENCE TO RELATED APPLICATIONS

This application claims the benefit under the Paris Convention of the May 31, 2011 filing date of U.S. Ser. No. 61/491,400. The disclosure of U.S. Ser. No. 61/491,400 is hereby incorporated herein by reference.

### TECHNICAL FIELD

The present disclosure relates to a high cut-off hemodialysis membrane for the treatment of anemia in hemodialysis patients, especially EPO resistant hemodialysis patients. The present disclosure further relates to methods of treating anemia in hemodialysis patients, especially EPO resistant dialysis patients.

### DESCRIPTION OF THE RELATED ART

Anemia is known to be one of the major complications among hemodialysis patients. The reasons are thought to be iron deficiency due to blood loss through dialysis filters or blood retention in the blood lines, infections and a reduced responsiveness to erythropoietin stimulating agents (ESAs)(Kainz et al. (2010); Nephrol. Dial. Transplant 25(11), 3701-6; Epub 2010 May 26). Anemia is characterized by a reduced number of red blood cells (RBCs) and/or by a reduced amount of hemoglobin (Hb) in the blood. The WHO defined anemia as a Hb level of less than 13.0 g/dl for adult males and 12 g/dl for premenopausal women (World Health Organ Tech Rep Ser. (1968) 405, 5-37: Nutritional anaemias. Report of a WHO scientific group.). Accordingly, severity of anemia is assessed by measuring Hb concentration. In general, the anemia of chronic hemodialysis patients is morphologically indistinguishable from the anemia of other diseases. It characteristically is hypoproliferative, i.e. the erythropoietic activity is low, consistent with insufficient erythropoietin stimulation. Proliferative activity is assessed by determination of the absolute reticulocyte count, the reticulocyte index, and the reticulocyte production index. The normal absolute reticulocyte count ranges from 40,000 to 50,000 cells/μL of whole blood. Hemoglobin and the red blood cells usually carry oxygen from the lungs to the tissues. Therefore, the decrease of hemoglobin and red blood cells causes a lack of oxygen in the tissues and organs of the body. The clinical consequences for hemodialysis patients may be severe. Many hemodialysis patients already suffer from coronary arteriosclerosis and, in addition, show symptoms of ischemia because of a reduced coronary vasodilatory reserve, altered myocardial oxygen consumption and uremic intramyocardial fibrosis. In such cases anemia worsens the state of the patients through further reduction of the available oxygen in the myocardium. Thus, anemia is a major risk for developing severe cardiac disease.

The existence and simplified production of recombinant human erythropoietin (rHuEpo) over the last years has helped to considerably improve the situation of hemodialysis patients suffering from anemia. Patients who get treated with EPO generally experience an increase of energy and appetite; they need fewer blood transfusions, and often experience an improved myocardial function. Meanwhile, more than 90% of end-stage renal disease patients require exogenous erythropoietin or transfusion to achieve and maintain target hemoglobin values (Kilpatrick et al. (2008); Clin. J. Am. Soc. Nephrol. 3 (1077-1083)). Kainz et al. (2010) could show that patients who respond well to the treatment with erythropoietin stimulating agents (ESA) and only need low weekly doses also exhibit the lowest risk of mortality.

The term “ESA” applies to all agents that augment erythropoiesis through direct or indirect action on the erythropoietin receptor. Currently available ESAs include epoetin alfa, such as, for example, Eprex®, epoetin beta, such as, for example, NeoRecormon®, methoxy polyethylene glycol-epoetin beta (e.g. Mircera®) and darbepoetin alfa, such as, for example, Aranesp®. Epoetin alfa and beta have been designed to resemble closely the endogenous molecule and have similar pharmacokinetics. Epoetin alfa and beta are synthetic forms of erythropoietin and produced in cell culture using recombinant DNA technology. They are considered “short-acting” in comparison to darbepoetin alfa, a synthetic form of erythropoietin with a prolonged half-life, which is considered “long-acting.” For the avoidance of doubt, the expressions “ESA” and “EPO” are mutually exchangeable for the purposes of this disclosure. Both expressions refer to substances as mentioned above which enhance erythropoiesis. The daily doses given may vary for the respective ESAs. The basic definition of the defined daily dose (DDD) is the assumed average maintenance dose per day for a drug used for its main indication in adults. Defined daily dose is a unit of measurement and does not necessarily reflect the recommended or Prescribed Daily Dose. It should be noted that doses for individual patients and patient groups will often differ from the DDD and will necessarily have to be based on individual characteristics (e.g. age and weight) and pharmacokinetic considerations. The DDD Index can be retrieved, for example, from the WHO Collaborating Centre for Drug Statistics Methodology.

Despite these considerable improvements based on the use of recombinant human erythropoietin in clinical practice, resistance to this therapy is not unusual. About 5% to 10% of the patients are considered to be EPO-resistant. Many patients, in addition, suffer from a rapid and significant drop in hematocrit during the course of various acute events that regularly take place in this sensitive population. The hematocrit may be seen as an integral part of a person's complete blood count results, along with hemoglobin concentration, white blood cell count, and platelet count. Such reduced responsiveness is sometimes also referred to as “EPO hypo-responsiveness”. EPO resistance is defined by the guidelines of the NKF KDOQI as the requirement of higher than average doses of ESA to achieve an increase of hemoglobin concentrations, or as the failure to increase the Hb level to greater than the target of 11 g/dl despite an ESA dose equivalent to epoetin greater than 500 IU per kg body weight and week (approx. 34 000 IU/week). According to the European Best Practices Guidelines (Guideline 14: Nephrol. Dial. Transplant. (1999) 14(suppl 5): 24), the definition of resistance to EPO is either failure to attain the target Hb concentration while receiving more than 300 IU per kg body weight and week (approx. 20 000 IU/week) of EPO subcutaneously, or a continued need for such dosage to maintain the target.

The usual amount of EPO which is administered to a hemodialysis patient is in the range of from 50 IU to 150 IU (“International Units”) per kg of body weight and week. The dose should not normally exceed 200 IU per kg body weight three times a week (approx. 13 600 IU).

Both the NKF KDOQI (“National Kidney Foundation Kidney Disease Outcomes Quality Initiative”) and the European Best Practices Guidelines recommend providing EPO in order to achieve certain target hemoglobin (Hb) levels. Currently, 11-12 g/dl is considered to be the preferable Hb level both in Europe and the US. In general, the initial EPO dose and EPO dose adjustments should be determined by the patient's Hb level, the target Hb level, the observed rate of increase in Hb level, and clinical circumstances.

The expression “EPO resistance” or “hypo-responsiveness” as used in the present application refers to a condition wherein patients either fail to attain the target hemoglobin (Hb) concentration while receiving more than 300 IU/kg body weight/week (˜20,000 IU/week) of epoietin or 1.5 mg/kg of darbepoetin alfa (˜100 mg/week) or have a continued need for such high doses to maintain the target. Hemoglobin target levels are preferably in the range of 9.0 to 12.0 g/dL.

The route of administering EPO should be determined by the chronic kidney disease stage, the treatment setting, efficacy considerations, and the class of EPO used. For patients being hemodialysis dependent, either subcutaneous or IV administration is possible.

There are, however, also risks connected with giving high doses of exogenous EPO. EPO use has been associated with hypertension, endothelial dysfunction, and prothrombotic and inflammatory states in hemodialysis patients (Agarwal (2006), Kidney Int. 69, S9-S12). In addition, erythropoietin therapy, especially with higher doses, is linked to high costs.

The most common cause of EPO hypo-responsiveness or resistance is the absolute or functional iron deficiency. Therefore, it is important to first consider whether the respective patient suffers from an iron deficiency. The serum ferritin level is the blood marker of storage iron. Tests that reflect adequacy of iron for erythropoiesis include TSAT (“transferrin saturation,” the ratio of serum iron and total iron-binding capacity, multiplied by 100), MCV (“mean cell volume”), and the related indices, percentage of hypochromic red blood cells (PHRC) and content of Hb in reticulocytes (CHr). The TSAT should be at least 20%, the ferritin concentration should reach at least 100 ng/ml blood.

In the absence of iron-deficiency, the following conditions are generally considered, jointly or individually, to cause reduced responsiveness to EPO therapy: chronic blood loss, hyperparathyroidism, aluminium toxicity, hemoglobinopathies, folate or vitamin B12 deficiency, multiple myeloma, hemolysis, drug intake, inadequate dialysis (low KT/V) or infections/inflammations, such as access infections, surgical inflammation etc. It is known, that a number of cytokines can influence early maturation of red cell precursors (Krantz (1994): Pathogenesis and treatment of the anemia of chronic diseases. Am J Med Sci 307: 353-359). A crucial role is attributed, for example, to IL-6. Erythropoiesis occurs in the bone marrow. The process of transforming erythroid precursors into reticulocytes and subsequently into mature erythrocytes involves some cytokines IL-3, IL-12, IGF-1 and granulocyte-monocyte colony-stimulating growth factor, whereas factors such as IL-1, IL-6, TNF alpha and INF gamma are able to block this process. Thus, in chronic inflammatory states, which can be assessed clinically using the plasma concentration of C-reactive protein (CRP), inhibition of erythropoiesis can lead to anemia and counteract the success of EPO therapy (López-Gómez et al. (2008): Factors that condition the response to erythropoietin in patients on hemodialysis and their relation to mortality. Kidney Int. 74 (suppl 111):S75-S81). Indeed, patients with acute or chronic infection, inflammatory disease or malignancy very often show a considerable resistance to EPO treatment, which often cannot be overcome even with very high doses of EPO (Macdougall (1995): Poor response to erythropoietin: practical guidelines on investigation and management. Nephrol Dial Transplant 10, 607-614). It has been contemplated that infection and numerous inflammatory conditions might represent the most important cause of ESA hypo-responsiveness after absolute and functional iron-deficiency (Kanaby et al. (2010): Erythropoiesis Stimulatory Agent-Resistant Anemia in Dialysis Patients: Review of Causes and Management. Blood Purif 29, 1-12). This is due to many underlying factors, including an enhanced incidence of infections, the uremic milieu, elevated levels of pro-inflammatory cytokines or frequent presence of arteriosclerosis (Malyszko et al. (2007): Hepcidin in Anemia and Inflammation in Chronic Kidney Disease. Kidney Blood Press Res 30, 15-30). Malyszko et al. state that, for example, the deteriorating renal function may enhance overall inflammatory responses because of the decreased renal clearance of factors that are directly or indirectly involved in inflammation. Iron metabolism is generally also disturbed in chronic inflammation diseases.

It has been suggested to manage such poor response to EPO by treating the underlying causes with antibiotics such as ciprofloxacin or by administering steroids (Macdougall (1995)), however with very limited success.

Attempts have been made to respond to general anemia in patients with chronic renal failure by adequate dialysis with high-flux dialysis (Locatelli et al. (2000): Effect of high-flux dialysis on the anaemia of hemodialysis patients. Nephrol Dial Transplant 15, 1399-1409). However, no difference in hemoglobin level increase could be detected between patients treated for three months with a high-flux biocompatible membrane in comparison with those treated with a standard membrane and no significant change in the iron and EPO therapy throughout this time.

Accordingly, while in a small number of some limited clinical trials certain positive effects were reported using the Filtryzer® BK-F dialyzer, comprising a PMMA membrane, this advantage could not be shown in the larger trial of Locatelli et al. Rather, the positive effects achieved in the small clinical trials were shown to be attributable to other factors.

The Filtryzer® BK-F PMMA membrane which was used by Locatelli et al. is often referred to as “protein-leaking” membrane and is an example for this type of membranes (Ward (2005), J Am Soc Nephrol 16, 2421-2430). These membranes provide a somewhat greater clearance of low molecular weight proteins and small protein-bound solutes than standard high-flux dialysis membranes. However, they do not reach the same openness and performance as the high cut-off membranes referred to below in the present invention. Higher molecular weight molecules seem rather to be removed by means of adsorption to the membrane than by genuine dialysis.

The expression “protein-leaking” membrane, as used in the present application, thus refers to membranes which generally would be referred to as high-flux membranes having a somewhat more open-pored structure than the average high-flux membrane. Sieving coefficients for selected proteins, protein losses etc. are lower than comparable values of high cut-off membranes according to the invention.

WO 2004/056460 discloses certain high cut-off membranes which can be used in dialyzers to eliminate circulating sepsis-associated inflammatory mediators more effectively than conventional dialysis membranes. These high cut-off membranes have a higher average pore size on the selective layer of the membrane than conventional membrane types and, connected therewith, higher sieving coefficients for larger molecules.

The mean pore size of a membrane gives an indication of the median or average size of the pores on a membrane surface. It may refer to the radius or the diameter. It also describes the particle size that the membranes will be able to reject or to let pass. Membrane pores tend to be rather non-uniform, and as such any assumption of shape and volume is mainly for the purpose of mathematical modeling and interpretation. However, the average pore size can give an accurate description and quantitative analysis of how a membrane will behave in certain situations.

The expression “molecular weight cut-off” or “MWCO” or “nominal molecular weight cut-off” is a specification commonly used to describe the retention capabilities of a membrane and refers to the molecular mass of a solute where the membranes have a rejection of 90% (see FIG. 2), corresponding to a sieving coefficient of 0.1. The MWCO can alternatively be described as the molecular mass of a solute, such as, for example, dextrans or proteins where the membranes allow passage of 10% of the molecules. The shape of the curve depends, for example, on the pore size distribution and is thus linked to the physical form of appearance of the membrane.

The expression “molecular weight rejection onset” or “MWRO” or “nominal molecular weight rejection onset,” as used herein, refers to the molecular mass of a solute where the membranes have a rejection of 10% (see FIG. 2), or, in other words, allow passage of 90% of the solute, corresponding to a sieving coefficient of 0.9.

The applicants have now found that high cut-off membranes can be used to effectively treat anemia in chronic hemodialysis patients, and especially in EPO resistant dialysis patients. The high permeability of the high cut-off membranes allows for an increased clearance of cytokines and other pro-inflammatory solutes, thus attenuating the inflammatory state.

It was found that especially in hemodialysis patients with a poor response to EPO and signs of chronic inflammation at the absence of absolute iron deficiency, the use of the high cut-off membrane leads to an improved EPO responsiveness and thus to an effective treatment of anemia. Said signs of chronic inflammation in connection with EPO hypo-responsiveness include, but are not limited to, CPR values of between 10 mg/l and 50 mg/l, especially CPR values of between 10 mg/l and 35 mg/l. However, CRP values of from 10 mg/l to 20 mg/l are usually a sufficient indicator of chronic inflammation.

The expression “EPO responsiveness” as used herein is defined as the weekly EPO dose per kg body weight of a patient, divided by the Hb (hemoglobin) value. In the routine laboratory test for hemoglobin (Hb), the Hb value is usually measured as total hemoglobin and the result is expressed as the amount of hemoglobin in grams (g) per liter (l) of whole blood.

In the context of the present invention, each reference to “anemic hemodialysis patients” or “anemia in hemodialysis patients” includes normal hemodialysis patients who are treated with standard doses of EPO, as well as patients with EPO resistance, if not indicated otherwise.

The effect of treating anemic hemodialysis patients with high cut-off membranes can alternatively or additionally be established by determining hepcidin concentrations. Hepcidin is a regulator of systemic iron availability, a small protein of 2.8 kD which is bound specifically to a large protein, alpha-2-macroglobulin in blood. The production of hepcidin is modulated in response to anemia, hypoxia or inflammation. This linkage supports its proposed role as a key mediator of anemia and inflammation (Young et al. (2009), Clin J Am Soc Nephrol 4, 1384-1387). Accordingly, hepcidin may be used as a marker for determining EPO responsiveness and/or chronic inflammation.

### SUMMARY

It is the object of the present invention to provide for a method of treating anemia in a hemodialysis patient, especially in an EPO resistant hemodialysis patient, comprising withdrawing and bypassing the blood from the patient in a continuous flow into contact with one face of an hemodialysis membrane, simultaneously passing dialysate solution in a continuous flow on an opposite face of the hemodialysis membrane to the side of the hemodialysis membrane in contact with the blood, the flow of the dialysate solution being countercurrent to the direction of flow of blood, and returning the blood into the patient, wherein the hemodialysis membrane is characterized in that it comprises at least one hydrophobic polymer and at least one hydrophilic polymer and in that it allows passage of substances having a molecular weight of up to 45 kD with a sieving coefficient measured in whole blood of between 0.1 and 1.0.

It is a further object of the present invention to provide for a method for reducing the EPO dose in IU which is administered per kg body weight three times per week to a hemodialysis patient suffering from anemia, especially to an EPO resistant hemodialysis patient, wherein the reduction rate lies in the range of more than 10%, preferably more than 20%, more preferably in the range of more than 30%, comprising withdrawing and bypassing the blood from the patient in a continuous flow into contact with one face of an hemodialysis membrane, simultaneously passing dialysate solution in a continuous flow on an opposite face of the hemodialysis membrane to the side of the hemodialysis membrane in contact with the blood, the flow of the dialysate solution being countercurrent to the direction of flow of blood, and returning the blood into the patient, wherein the hemodialysis membrane is characterized in that it comprises at least one hydrophobic polymer and at least one hydrophilic polymer and in that it allows passage of substances having a molecular weight of up to 45 kD with a sieving coefficient measured in whole blood of between 0.1 and 1.0.

It is a another aspect of the present invention to provide for a dialysis membrane comprising at least one hydrophobic polymer and at least one hydrophilic polymer, wherein the membrane allows the passage of molecules having a molecular weight of up to 45 kDa with a sieving coefficient of from 0.1 to 1.0 in presence of whole blood, for treating anemia in a hemodialysis patient, especially in an EPO resistant hemodialysis patients.

It is also an aspect of the present invention to provide for a dialysis membrane comprising at least one hydrophobic polymer and at least one hydrophilic polymer, wherein the membrane has a molecular weight cut-off in water, based on dextran sieving coefficients, of between 90 and 200 kD, for treating anemia in hemodialysis patients, especially in EPO resistant hemodialysis patients.

In one embodiment of the invention, the hemodialysis treatment is performed from 2 to 4 times per week for a period of from 2 to 6 hours, respectively, with a membrane according to the invention (FIG. 3A). In other words, the standard hemodialysis filter is completely exchanged with a filter with a membrane according to the invention. A hemodialysis patient suffering from anemia, especially a EPO resistant patient, is thus being treated, for a certain period of time, only with such hemodialysis filter according to the invention. In one embodiment of the invention, the treatment may continue until the signs of chronic inflammation and/or EPO resistance are no longer diagnosed and/or the target hemoglobin level has been reached. In another embodiment of the invention, the treatment regiment as described may be applied for a period of from 4 to 12 weeks. In yet another embodiment of the invention, the treatment may continually be used for a hemodialysis patient who is prone to developing EPO resistance and/or suffers from chronic inflammation, especially for CRP values of from 10 to 50 mg/l, more special for CRP values of from 10 to 20 mg/l.

In another embodiment of the invention, one of three hemodialysis treatments per week is performed for a period of 2 to 6 hours with a membrane according to the invention, whereas two of three hemodialysis treatments per week comprise the use of a standard high-flux hemodialysis membrane (FIG. 3B). Said treatment may be used in cases where standard dialysis is recommended in addition to using a hemodialysis filter according to the invention. In one embodiment of the invention, the treatment may continue until the signs of chronic inflammation and/or EPO resistance are no longer diagnosed, or until the Hb target value has been reached. In another embodiment of the invention, the treatment regime as described may be applied for a period of from 4 to 12 weeks. In yet another embodiment of the invention, the treatment may continually be used for a hemodialysis patient who is prone to developing EPO resistance and/or suffers from chronic inflammation, especially for CRP values of from 10 to 50 mg/l, more special for CRP values of from 10 to 20 mg/l.

In a further embodiment of the present invention, the hemodialysis treatment for a period of 2 to 6 hours is performed with a membrane according to the invention every other dialysis treatment, whereas the other hemodialysis treatment comprises the use of a standard high-flux hemodialysis membrane (FIG. 3C). Said treatment may be used in cases where standard dialysis is recommended in addition to using a hemodialysis filter according to the invention. In one embodiment of the invention, the treatment may continue until the signs of chronic inflammation and/or EPO resistance are no longer diagnosed, or until the Hb target value has been reached. In another embodiment of the invention, the treatment regime as described may be applied for a period of from 4 to 12 weeks. In yet another embodiment of the invention, the treatment may continually be used for a hemodialysis patient who is prone to developing EPO resistance and/or suffers from chronic inflammation, especially for CRP values of from 10 to 50 mg/l, more special for CRP values of from 10 to 20 mg/l.

In yet another embodiment of the invention, a treatment according to the invention is applied to anemic hemodialysis patients, especially anemic EPO resistant hemodialysis patients having an adequate iron status, i.e. patients with no absolute iron deficiency. An adequate iron status is characterized by a transferrin saturation of at least 20% and a ferritin concentration of at least 100 ng/ml.

In another embodiment of the invention, the treatment is applied to anemic hemodialysis patients, especially anemic EPO resistant hemodialysis patients with signs of chronic inflammation. Chronic inflammation is indicated, in the context of the present invention, by CRP values of more than 10 mg/l. In yet another embodiment of the present invention, chronic inflammation is indicated, in the context of the present invention, by CRP values of from 10 mg/l to 50 mg/l, especially CRP values of from 10 mg/l to 20 mg/l.

The expression “high cut-off membrane” in the context of the present invention refers to membranes which allow substances with a molecular weight of up to 45 kD to pass the membrane with a sieving coefficient measured in blood according to EN1283 of between 0.1 and 1.0.

The expression “high cut-off membrane,” in the context of the present invention, further refers to membranes which are defined by an average pore size on the selective layer of more than 7 nm, in general from between 8 to 12 nm, as determined according to equation [1] below and based on dextran sieving coefficients determined according to Example 3. The average pore size of high cut-off membranes is larger than the average pore size of conventional high-flux membranes, including so-called protein-leaking membranes, which have average pore sizes of up to 7 nm, generally from between 5 to 7 nm.

The expression “high cut-off membrane,” in the context of the present invention, further refers to membranes which have a molecular weight cut-off in water, based on dextran sieving coefficients, of between 90 and 200 kD, as determined according to Example 3.

In one embodiment of the invention, the high cut-off dialysis membrane which is used in a treatment according to the invention has a molecular weight cut-off in water, based on dextran sieving coefficients, of between 120 and 180 kD.

In another embodiment of the present invention, the high cut-off dialysis membrane is characterized by an average pore size, on the selective layer, of between 8 and 12 nm as determined according to equation [1] of Aimar et al.: “A contribution to the translation of retention curves into pore size distributions for sieving membranes.” J. Membrane Sci. 54 (1990)339-354.

α=0.33 (MM)^{0.46} [1]

In equation [1], α represents the radius (in Å) from which the pore diameter can be determined. MM represents the molecular weight or molar mass (in g/mol) of dextrans. The measurement of sieving coefficients for a certain number of molecular sizes of various dextrans (see Example 4), translates into and can be used to describe physical properties of a membrane, exemplified by, for example, the pore-size distribution of a membrane. Accordingly, it is possible to compare different membranes based on their dextran sieving profiles, which can be empirically obtained, regarding their sieving or retention properties, nominal molecular weight cut-off, average pore size and mean pore size distribution (FIGS. 5 and 6).

In yet another embodiment of the present invention, the high cut-off dialysis membrane is characterized by a sieving coefficient for albumin, in plasma, of from 0.05 to 0.25 and a sieving coefficient for myoglobin, in plasma, of from 0.85 to 1.0. If not indicated otherwise, sieving coefficients for selected proteins, such as albumin, myoglobin or the like are determined in plasma or whole blood according to EN1283, incorporated herein by reference.

In yet another embodiment of the invention, the high cut-off dialysis membrane is characterized by a clearance (ml/min) for κ-FLC of from 35 to 40, and for κ-FLC of from 30 to 35.

In yet another embodiment of the present invention, the high cut-off dialysis membrane as used in a treatment according to the invention is characterized by a nominal molecular weight cut-off (MWCO) of from 90 to 200 kD (FIGS. 2 and 5).

In yet another embodiment of the present invention, the high cut-off dialysis membrane is characterized by a molecular weight rejection onset (MWRO) of from 10 to 20 kD (FIGS. 2 and 5).

In yet another embodiment of the invention, the high cut-off dialysis membrane is characterized by a Δ Molecular Weight (Δ MW) between MWCO and MWRO as defined in FIG. 2 of at most 170 kD (see also FIG. 5). As Δ Rejection always remains 0.8, Δ MW is an indicator for the slope of the retention (or sieving) curve and the selectivity of the membrane. In one embodiment of the invention, Δ MW is between 90 and 170 kD. In another embodiment of the invention, Δ MW is between 100 and 170 kD. In yet another embodiment of the invention, Δ MW is between 120 and 160 kD.

### BRIEF DESCRIPTION OF THE DRAWINGS

FIG. 1 schematically depicts the basis for a method of treating anemia in EPO resistant hemodialysis patients. The hemodialysis treatment with a high cut-Off membrane reduces or removes from the blood of a patient higher molecular weight substances which result in or contribute to conditions of chronic inflammation. Anemia and EPO hypo-responsiveness are clinical symptoms of such chronic inflammation. The control of the factors leading to chronic inflammation consequently improves EPO responsiveness. Accordingly, this will lead to the amelioration of the anemic condition of an EPO-resistant patient.

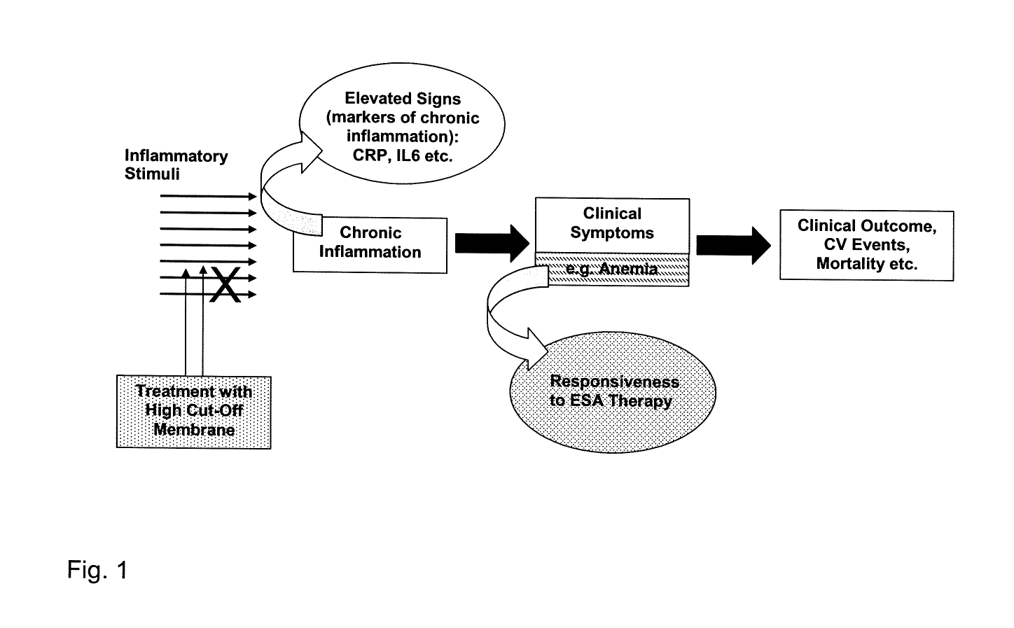

FIG. 2 generally depicts the meaning of the expressions “molecular weight cut-off” (MWCO) and “molecular weight rejection onset” (MWRO). MWCO refers to the molecular mass of a solute where the membrane has a rejection of greater than 90%. MWRO refers to the molecular mass of a solute where the membrane has a rejection of 10%. In the exemplary curve of FIG. 2, the MWCO would be about 52 kD, the MWRO would be about 8.3 kD. The Δ Rejection value always remains 0.8. The Δ Molecular Weight value is a measure for the selectivity of the membrane.

FIG. 3 shows three different schemes for a treatment according to invention. “HD” refers to a standard dialysis treatment comprising the use of conventional high-flux hemodialysis membranes, such as a Polyflux® P170H membrane (Gambro Lundia AB). FIG. 3A refers to a treatment wherein a high cut-off membrane is generally used for all dialysis treatments applied to an EPO-resistant hemodialysis patient, generally comprising 2 to 4 hemodialysis treatments per week. FIG. 3B refers to a scheme which comprises the use of a high cut-off membrane in one out of three hemodialysis treatments per week. FIG. 3C refers to a scheme which comprises the use of a high cut-off membrane in every other hemodialysis treatment.

FIG. 4A exemplarily shows the sieving coefficients of a standard high-flux dialysis membrane and a high cut-off dialysis membrane. The sieving coefficients shown have been derived from clinical studies. Accordingly, the data refer to sieving coefficients for certain proteins as determined in whole blood. Dialysis has been performed according to the method described in Morgera et al. (2003): Intermittent high permeability hemofiltration in septic patients with acute renal failure. Intensive Care Med. 29, 1989-1995. The HCO 11008 dialyzer (Gambro Lundia AB) serves as an example for a High Cut-Off dialysis membrane. The conventional high-flux dialyzer used is Polyflux 170H (Gambro Lundia AB). FIGS. 4B, C and D depict the structural details of the HCO 1100® dialyzer, showing the lumen surface (FIG. 4B), a close up of a membrane cross section (FIG. 4C) and a close up of the selective layer of the membrane (FIG. 4D). With markedly larger pore sizes than conventional high-flux membranes, the membrane has a significantly higher permeability for substances in the middle molecular weight range. In addition, the membrane's specific structure and narrow pore size distribution essentially ensure the retention of larger proteins with molecular weights greater than 60 kDa, such as clotting factors and immunoglobulins.

FIG. 5 depicts the dextran sieving curves of two high cut-off membranes (HCO 1100®, Theralite®) and two standard high flux membrane (Polyflux® Revaclear, Polyflux® P170H), all of Gambro Lundia AB, as well as of the Filtryzer® BK-F of Toray, generally referred to as “protein-leaking.” The sieving curves have been determined according to the method as described in Example 3. The Figure shows that the high cut-off membranes differ significantly with regard to MWCO and MWRO from the high-flux membranes, including the “protein-leaking” membrane, due to its increased average pore size. Dotted bars indicate the MWCO and MWRO which, according to the invention, define high-flux and high cut-off membranes, respectively. Horizontal lines indicate sieving coefficients of 0.1 and 0.9, respectively.

FIG. 6 depicts the pore size distribution (radius) in nm of two high cut-off membranes (HCO 1100®, Theralite®) and two standard high flux membrane (Polyflux® Revaclear, Polyflux® P170H), all of Gambro Lundia AB, as well as of the Filtryzer® BK-F of Toray, generally referred to as “protein-leaking,” as determined from the dextran sieving coefficients (see FIG. 5). The vertical line at 3.5 nm (radius) reflects the line which can be drawn between the average pore sizes of high-flux membranes and high cut-off membranes.

FIG. 7 depicts the first results obtained for the development of hepcidin concentrations during a study which compares patient values wherein two groups of patients are compared (Example 5). In one group the treatment comprised high cut-off dialyzer types (FIG. 7A, Group Theralite), in another group standard dialyzers were used (FIG. 7B, Control Group). Hepcidin concentrations have been measured with a commercially available test kit, “Hepcidin Elisa E91979Hu” from USCN Life Science, Inc. Time points refer to values obtained before the start of the treatment (T0), after one week of treatment (T1) and after four weeks of treatment (T4).

### DETAILED DESCRIPTION

The current invention is directed to a method of treating anemia in a hemodialysis patient, especially in an EPO resistant hemodialysis patient, comprising withdrawing and bypassing the blood from the patient in a continuous flow into contact with one face of an hemodialysis membrane, simultaneously passing dialysate solution in a continuous flow on an opposite face of the hemodialysis membrane to the side of the hemodialysis membrane in contact with the blood, the flow of the dialysate solution being countercurrent to the direction of flow of blood, and returning the blood into the patient, wherein the hemodialysis membrane is characterized in that it allows passage of molecules having a molecular weight of up to 45 kDa in the presence of whole blood with a sieving coefficient of from 0.1 to 1.0.

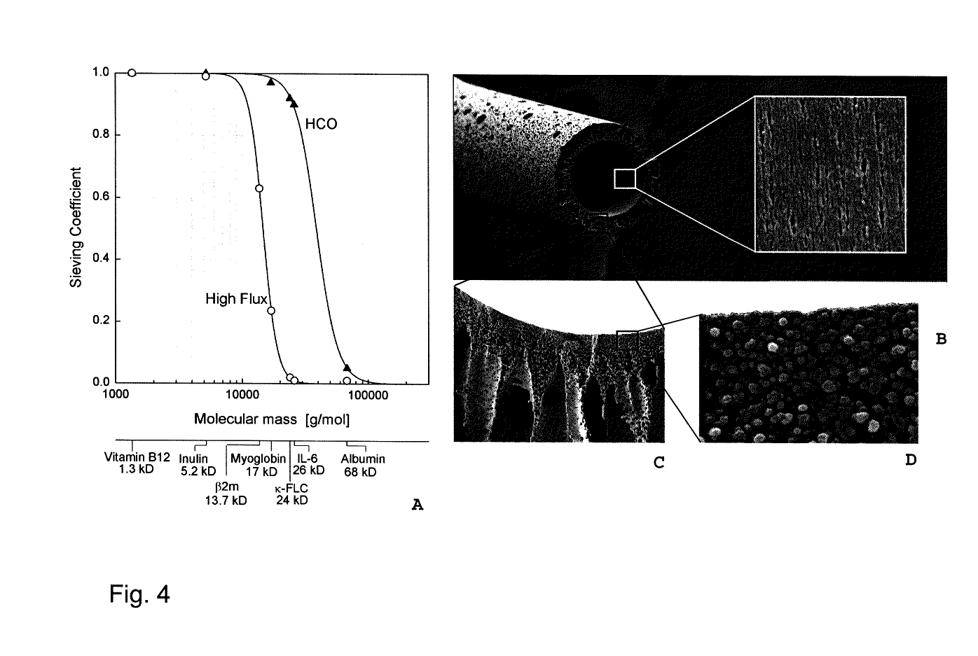

As can be seen from FIG. 4, the high cut-off dialysis membrane allows the limited passage, in whole blood, of molecules of up to 70 kD, including also, to a certain limited extend, albumin with a molecular weight of 68 kD. FIG. 4 demonstrates that high-flux membranes according to the invention, in whole blood, allow the passage of molecules up to about 25 kD only.

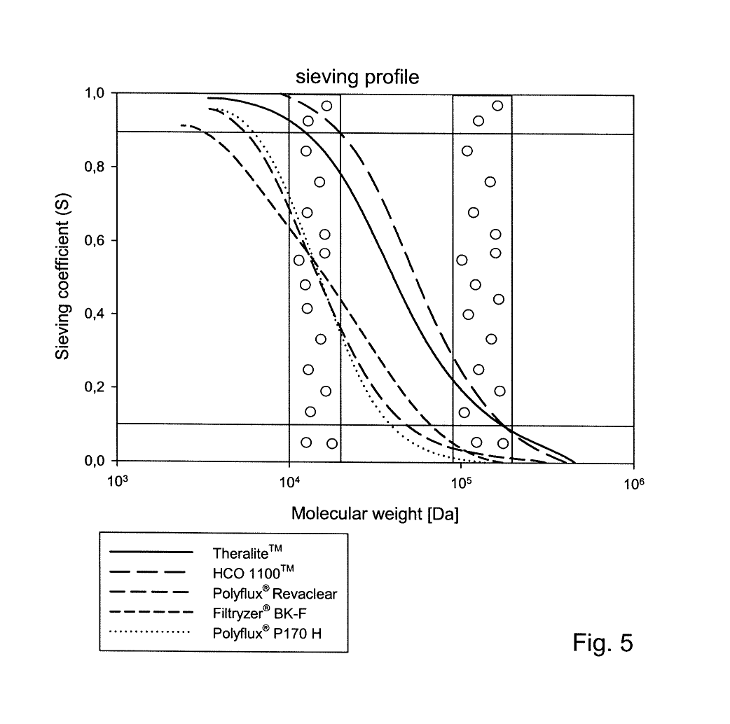

In water, the molecular weight cut-off (MWCO) of the high cut-off dialysis membrane, is in the range of from 90 to 200 kD and is considerably higher than the MWCO of conventional high-flux membranes (see FIGS. 4 and 5), which generally lies in the range of 30 to 60 kDa in water (Example 3), including also the so called protein leaking membranes.

The higher permeability of the high cut-off membrane according to the invention allows for increased clearance of cytokines and other pro-inflammatory solutes, which attenuates the inflammatory state. In hemodialysis patients with anemia, poor response to EPO therapy, signs of chronic inflammation and absence of absolute iron deficiency, this leads to an improved EPO responsiveness.

Accordingly, the above method also provides for a possibility to reduce the EPO dose in IU which is administered per kg body weight three times per week to a hemodialysis patient suffering from anemia, especially patients who also suffer from EPO resistance. The treatment according to the invention is designed to reduce or remove such molecules which are connected to the condition of anemia especially in conjunction with EPO hypo-responsiveness as discussed before. The amelioration of the condition of the patient based on the present treatment will allow reducing EPO doses which have to be administered to the patients. The reduction rates at least lie in the range of more than 10% relative to the EPO dose which is needed to maintain a target hemoglobin value. It is an object of the present invention to achieve reduction rates of more than 20%, preferably more than 30%.

In general, a treatment according to the invention is applied to anemic hemodialysis patients, especially anemic EPO resistant hemodialysis patient having an adequate iron status, i.e. patients with no absolute iron deficiency. An adequate iron status is characterized by a transferrin saturation of at least 20% and a ferritin concentration of at least 100 ng/ml. A hemodialysis patient with absolute iron deficiency should first be treated with regard to his or her iron status and his or her responsiveness to EPO should be monitored. The present treatment is indicated if EPO hypo-responsiveness is not improving in spite of a good iron status, as this is an indication that EPO hypo-responsiveness is linked to other problems which can be treated via the presently suggested treatment with a high cut-off dialysis membrane.

Accordingly, it is one aspect of the invention, to apply the treatment to hemodialysis patients with signs of chronic inflammation and an absence of absolute iron deficiency, especially to those patients showing EPO hypo-responsiveness. Chronic inflammation is indicated, in the context of the present invention, by CRP values of more than 10 g/ml. In yet another embodiment of the present invention, chronic inflammation is indicated, in the context of the present invention, by CRP values of from 10 mg/l to 50 mg/l, especially by CRP values of from 10 mg/l to 20 mg/l.

Generally, the present treatment is directed to EPO resistant hemodialysis patients with signs of chronic inflammation. Chronic inflammation is indicated, in the context of the present invention, by CRP values of more than 10 g/ml. The CRP values will generally lie in the range of from 10 mg/l to 20 mg/l. However, CRP values of up to 50 mg/l may occur.

The dialysis according to the invention is carried out by passing the patient's blood into a high cut-off membrane dialyzer according to the invention. The dialysate side of the dialyzer provides for the dialysate. Water-soluble and protein bound molecules which are connected to EPO hypo-responsiveness in the blood are transported through the membrane and into the dialysate solution on the other side. The cleansed blood returns to the patient.

Various treatment regimes comprising dialysis with a high cut-off membrane can be envisioned for anemic hemodialysis patients, especially anemic EPO resistant hemodialysis patients. Exemplary treatment regimes which may be applied according to the invention are as follows.

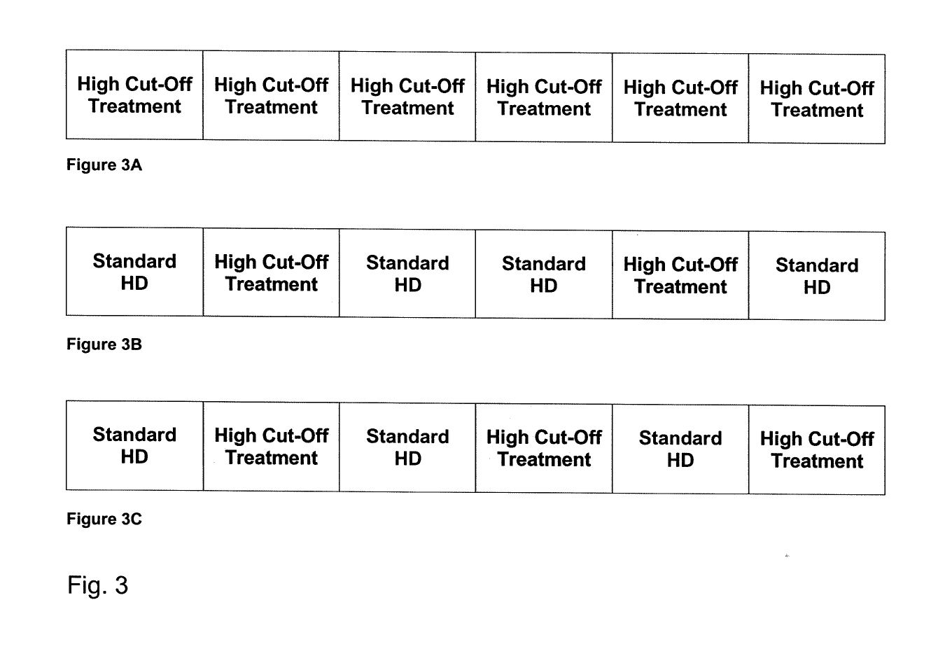

In one embodiment of the invention, the hemodialysis treatment is performed from 2 to 4 times per week for a period of from 2 to 6 hours with a membrane according to the invention (FIG. 3A). In other words, the standard hemodialysis filter is completely exchanged with a filter with a membrane according to the invention. A hemodialysis patient suffering from EPO resistance is thus being treated, for a certain period of time, only with such hemodialysis filter according to the invention. In one embodiment of the invention, the treatment may continue until the signs of chronic inflammation and/or EPO resistance are no longer diagnosed and/or the target Hb value has been reached. In another embodiment of the invention, the treatment regime as described may be applied for a period of from 4 to 12 weeks. In such treatment regime it will be important to monitor a sufficient removal of small molecules such as urea from blood.

In another embodiment of the invention, the hemodialysis treatment regime is performed with a high cut-off membrane which has a urea clearance of at least 170 ml/min at a Q_{B} of 200 ml/min and a Q_{D} of 500 ml/min (UF=0 ml/min). In yet another embodiment of the invention, the dialysis treatment according to the invention must ensure a Kt/V of >1.2.

In yet another embodiment of the invention, a patient's total albumin loss should be limited and not exceed about 40 g per week.

In another embodiment of the invention, one of three hemodialysis treatments per week is performed for a period of 2 to 6 hours with a membrane according to the invention, whereas two of three hemodialysis treatments per week comprise the use of a standard hemodialysis membrane (FIG. 3B). Said treatment may be used in cases where standard dialysis is recommended in addition to using a hemodialysis filter according to the invention. In one embodiment of the invention, the treatment may continue until the signs of chronic inflammation and/or EPO resistance are no longer diagnosed and/or until target Hb values have been reached. In another embodiment of the invention, the treatment regiment as described may be applied for a period of from 4 to 12 weeks. In yet another embodiment of the invention, the treatment may continually be used for a hemodialysis patient who is prone to developing EPO resistance and/or suffers from chronic inflammation, especially for CRP values of from 10 to 20 mg/l.

In a further embodiment of the present invention, the hemodialysis treatment for a period of 2 to 6 hours is performed with a membrane according to the invention every other dialysis treatment, whereas the other hemodialysis treatment comprises the use of a standard hemodialysis membrane (FIG. 3C). Said treatment may be used in cases where standard dialysis is recommended in addition to using a hemodialysis filter according to the invention. In one embodiment of the invention, the treatment may continue until the signs of chronic inflammation and/or EPO resistance are no longer diagnosed and/or the target Hb value has been reached. In another embodiment of the invention, the treatment regiment as described may be applied for a period of from 4 to 12 weeks. In yet another embodiment of the invention, the treatment may continually be used for a hemodialysis patient who is prone to developing EPO resistance and/or suffers from chronic inflammation, especially for CRP values of from 10 to 20 mg/l.

Depending on the specific condition of a patient, such treatment regimes or routines can be applied singularly or dynamically, i.e. they may be interchanged or subsequently be used for certain periods of time.

Dialysis machines which can be used for performing a treatment according to the invention are standard dialysis machines which can accurately control and monitor the ultrafiltration rate. Examples for such devices are the AK 96™, AK 200™ S and AK 200™ ULTRA S, PrismafleX eXeed™ or the Artis™ dialysis machines of Gambro Lundia AB. However, any other dialysis machine having UF control can also be used for the treatment.

Parameters for performing a treatment according to the invention can be adjusted to standard dialysis treatment parameters and the specifications of the high cut-off membrane. Typical flow rates used for the present treatment may vary. It is advantageous to use flow rates with a Q_{B} (blood flow) of 100-500, preferably 250-400 ml/min and a Q_{D} (dialysate flow rate) of 100-1000, preferably 300-500 ml/min.

Typically, the high cut-off membranes according to the invention have a water permeability of >40 ml/h per mmHg/m² in vitro.

They generally have a β₂-microglobulin clearance of at least 80 ml/min for conventional hemodialysis with a blood flow rate of 300 to 400 ml/min (UF=0 ml/min), a clearance for myoglobin at Q_{B}=200 ml/min and Q_{D}=500 ml/min (UF=0 ml/min) of between 50 and 150 ml/min, and a clearance for urea at Q_{B}=200 ml/min and QD=500 ml/min (UF=0 ml/min) of at least 150 ml/min, generally between 150 and 250 ml/min.

Albumin loss (HD) in vitro at Q_{B}=200 ml/min and Q_{D}=500 ml/min (UF=0 ml/min) as determined with bovine plasma having a protein level of 60 g/l (37° C.) and an albumin level of 20-30 g/l and after four hours of treatment is, at most, 7 g/h (±20%). At the same time, the albumin clearance at Q_{B}=250 ml/min and Q_{D}=500 ml/min (UF=0) is between 0.5 and 4 ml/min. Albumin loss in vivo is between 0.5 and 2 g per hour of dialysis at Q_{B}=200 ml/min and Q_{D}=500 ml/min.

Membrane passage of a solute, such as a protein which needs to be removed from blood, is described by means of the sieving coefficient S. The sieving coefficient S is calculated according to S=(2C_{F})/(C_{Bin}+C_{Bout}), where C_{F} is the concentration of the solute in the filtrate and C_{Bin} is the concentration of a solute at the blood inlet side of the device under test, and C_{Bout} is the concentration of a solute at the blood outlet side of the device under test. A sieving coefficient of S=1 indicates unrestricted transport while there is no transport at all at S=0. For a given membrane each solute has its specific sieving coefficient. Sieving coefficients typically are plotted versus increasing molecular mass to show the sieving coefficient curve. A sieving coefficient of e.g. 0.9 thus indicates that 90% of the solute is allowed to pass the membrane. This corresponds to a retention of the respective solute of 10%. Furthermore, the sieving coefficients or the sieving curve of a membrane allows determining the nominal cut-off of a membrane corresponding to a sieving coefficient of 0.1.

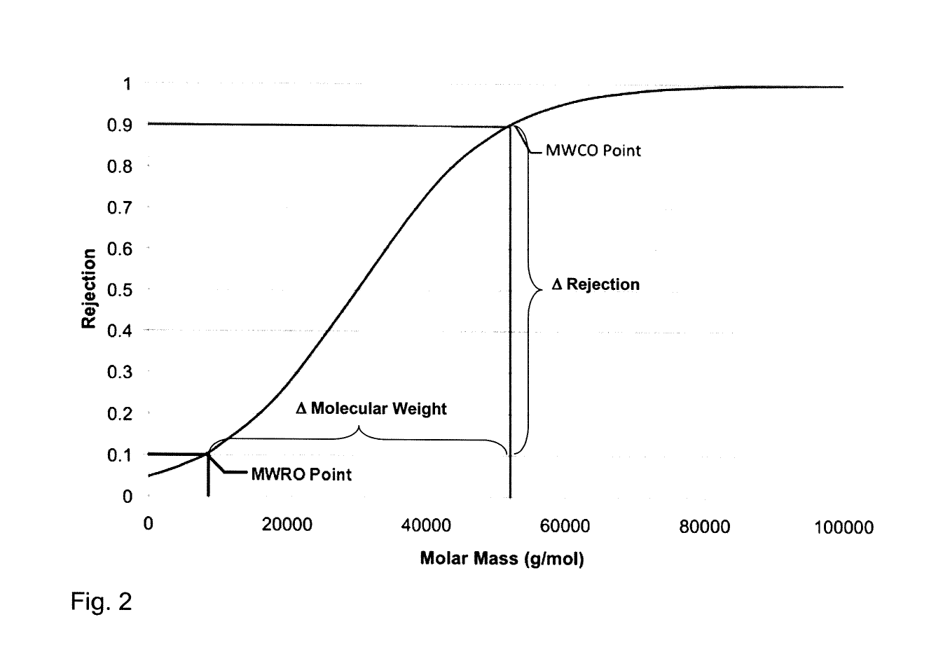

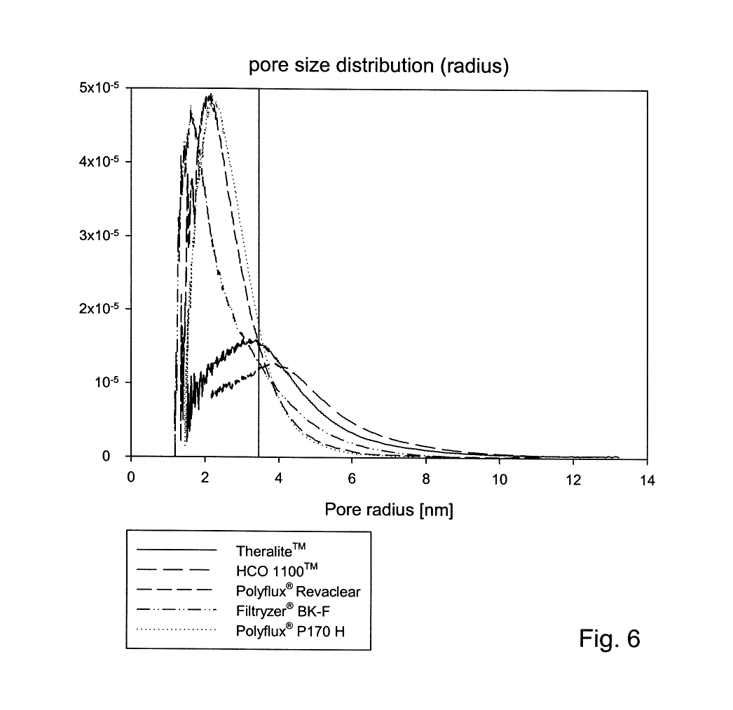

High cut-off membranes which may advantageously be used according to the invention can, for example, also be described by their specific sieving curves in water as determined with dextrans. The sieving curves allow determining the MWCO as well as the MWRO in water. Both values may serve to determine ΔMW between the rejection onset point and the cut-off point (see FIG. 2). In addition, the sieving curves serve as a basis for determining, for example, the average or mean pore size or pore size distribution of a membrane on the selective layer. There is a factual and mathematical correlation between the sieving characteristics of a membrane and its pore structure. The mean pore size or pore size distribution can be determined according to Aimar et al (1990) from the dextran sieving curve. The dextran sieving curves can be determined as described in Example 3 and pore size distribution and average pore size can be determined therefrom (FIGS. 5 and 6).

Accordingly, the high cut-off dialysis membrane as preferably used according to the invention is characterized by a nominal molecular weight cut-off (MWCO), in water, of from 90 to 200 kD (FIGS. 2 and 5).

The high cut-off dialysis membrane is further characterized by a nominal molecular weight rejection onset (MWRO) of from 10 to 20 kD (FIGS. 2 and 5).

In a further embodiment of the invention the high cut-off dialysis membrane is thus characterized by a Δ Molecular Weight (ΔMW) between MWCO and MWRO as defined in FIG. 2 of at most 170 kD. As Δ Rejection always remains 0.8, ΔMW is an indicator for the slope of the retention (or sieving) curve and the selectivity of the membrane. In one embodiment of the invention, the ΔMW is between 90 and 170. In another embodiment of the invention the ΔMW is between 100 and 170 kD.

In yet another embodiment of the invention the high cut-off dialysis membrane is characterized by an average pore size radius on the selective layer, based on dextran sieving curves as determined according to Example 3, of more than 4 nm. In one embodiment of the invention, said average pore size radius is between about 4 nm and 12 nm. In another embodiment, said average pore size radius is between 6 nm and 11 nm. In yet another embodiment of the invention the average pores size radius is between 7 nm and 12 nm.

In one embodiment of the invention, the sieving coefficients of high cut-off membranes according to the invention are in the range of from 0.9 to 1.0 for β2-microglobulin, of from 0.8 to 1.0 for myoglobin and of from 0.01 to 0.25, preferably 0.05 to 0.2, for albumin, when measured in plasma according to EN 1283. Table I provides for exemplary values for a high cut-off membrane in comparison to a standard high-flux membrane.

TABLE I
Sieving Coefficients for a conventional high-flux dialysis membrane,
Polyflux ® 170H (Gambro Lundia AB), and a high cut-off dialysis
membrane, HCO 1100 ® (Gambro Lundia AB). The sieving coefficients
in plasma and water have been determined according to DIN EN1283.
Sieving coefficients (%)

| | Plasma |
|---|---|
| Filter type | Validation |
| P170H | |
| Vitamin B12 | 100 |
| Inulin | 100 |
| beta2M | 75 |
| Myoglobin | 25 |
| Albumin | <1 |
| HCO 1100 | |
| Vitamin B12 | 100 |
| Inulin | 100 |
| Myoglobin | 95 |
| Albumin | 10 |

HCO1100: Q_{B} = 400 mL/min; UF = 80 mL/min.
P170H: Q_{B} = 500 ml/min; UF = 100 ml/min.
For the sieving coefficients in aqueous solution the following flow rates were used: HCO1100: Q_{B} = 228 ml/min, UF = 46 ml/min. P170H: Q_{B} = 234 ml/min, UF = 67 ml/min.

In one embodiment of the invention, the membrane is a permselective membrane of the type disclosed in WO 2004/056460. Such membranes preferably allow passage of molecules having a molecular weight of up to 45 kDa in the presence of whole blood with a sieving coefficient of between 0.1 and 1.0. The molecular weight cut-off in water as determined with dextrans may reach values of up to 200 kD. In one embodiment of the invention, the membrane takes the form of a permselective asymmetric hollow fiber membrane. It preferably comprises at least one hydrophobic polymer and at least one hydrophilic polymer. Preferably the polymers are present as domains on the surface.

In one embodiment, the membrane allows for the passage of free light chains (FLC). That is, the κ or λ free light chains pass through the membrane. High flux membranes, with smaller pore sizes, sometimes also referred to as “protein-leaking membranes,” have been observed to remove some free light chains. However, this appears to be primarily due to binding of the FLC onto the dialysis membranes. FLC may be used as markers of middle molecular weight proteins. Although clearing of free light chains is not a primary target of the invention, their reduction can be used as an indicator of membrane functionality.

According to another aspect of the invention, a dialysis device for the treatment of EPO hypo-responsiveness in hemodialysis patients is provided, wherein the device comprises a high cut-off dialysis membrane according to the invention.

It is provided, in a further aspect of the invention, dialysis system wherein the high cut-off dialysis membrane has a clearance (ml/min) for κ-FLC of from 30 to 45, and for λ-FLC of from 28 to 40. Clearance is determined in vitro (±20%) with Q_{B}=250 ml/min, Q_{D}=500 ml/min, UF=0 ml/min in bovine plasma having a protein level of 60 g/l at 37° C. The plasma level for human κ=500 mg/l and for human λ=250 mg/l.

In one aspect of the present invention, the high cut-off dialysis membrane comprises at least one hydrophilic polymer and at least one hydrophobic polymer. In one embodiment, at least one hydrophilic polymer and at least one hydrophobic polymer are present in the dialysis membrane as domains on the surface of the dialysis membrane.

The hydrophobic polymer may be chosen from the group consisting of polyarylethersulfone (PAES), polypropylene (PP), polysulfone (PSU), polymethylmethacrylate (PMMA), polycarbonate (PC), polyacrylonitrile (PAN), polyamide (PA), polytetrafluorethylene (PTFE) or combinations thereof. In one embodiment of the invention, the hydrophobic polymer is chosen from the group consisting of polyarylethersulfone (PAES), polypropylene (PP), polysulfone (PSU), polycarbonate (PC), polyacrylonitrile (PAN), polyamide (PA) polytetrafluorethylene (PTFE) or combinations thereof.

The hydrophilic polymer may be chosen from the group consisting of polyvinylpyrrolidone (PVP), polyethyleneglycol (PEG), polyvinylalcohol (PVA), and copolymer of polypropyleneoxide and polyethyleneoxide (PPO-PEO). In one embodiment of the invention, the hydrophilic polymer may be chosen from the group consisting of polyvinylpyrrolidone (PVP), polyethyleneglycol (PEG) and polyvinylalcohol (PVA).

In one embodiment of the invention, the high cut-off dialysis membrane is a hollow fiber having an asymmetric structure with a separation layer present in the innermost layer of the hollow fiber. In one embodiment of the invention, the high cut-off dialysis membrane has at least a 3-layer asymmetric structure, wherein the separation layer has a thickness of less than 0.5 μm. In one embodiment, the separation layer contains pore channels having an average pore size of more than 7 nm, generally between 8 and 12 nm as determined according to Aimar et al. (1990) and based on dextran sieving coefficients. The average pore size (diameter) is generally above 7 nm for this type of membrane (FIG. 6). The next layer in the hollow fiber membrane is the second layer, having the form of a sponge structure and serving as a support for said first layer. In a preferred embodiment, the second layer has a thickness of about 1 to 15 μm. The third layer has the form of a finger structure. Like a framework, it provides mechanical stability on the one hand; on the other hand a very low resistance to the transport of molecules through the membrane, due to the high volume of voids. During the transport process, the voids are filled with water and the water gives a lower resistance against diffusion and convection than a matrix with a sponge-filled structure having a lower void volume. Accordingly, the third layer provides mechanical stability to the membrane and, in a preferred embodiment, has a thickness of 20 to 60 μm.

In one embodiment, the high cut-off dialysis membrane also includes a fourth layer, which is the outer surface of the hollow fiber membrane. In this embodiment, the outer surface has openings of pores in the range of 0.5 to 3 μm and the number of said pores is in the range of from 10,000 to 150,000 pores/mm², preferably 20,000 to 100,000 pores/mm². This fourth layer preferably has a thickness of 1 to 10 μm.

The manufacturing of a high cut-off dialysis membrane follows a phase inversion process, wherein a polymer or a mixture of polymers is dissolved in a solvent to form a polymer solution. The solution is degassed and filtered and is thereafter kept at an elevated temperature. Subsequently, the polymer solution is extruded through a spinning nozzle (for hollow fibers) or a slit nozzle (for a flat film) into a fluid bath containing a non-solvent for the polymer. The non-solvent replaces the solvent and thus the polymer is precipitated to an inverted solid phase.

To prepare a hollow fiber membrane, the polymer solution preferably is extruded through an outer ring slit of a nozzle having two concentric openings. Simultaneously, a center fluid is extruded through an inner opening of the nozzle. At the outlet of the spinning nozzle, the center fluid comes in contact with the polymer solution and at this time the precipitation is initialized. The precipitation process is an exchange of the solvent from the polymer solution with the non-solvent of the center fluid.

By means of this exchange the polymer solution inverses its phase from the fluid into a solid phase. In the solid phase the pore structure, i.e. asymmetry and the pore size distribution, is generated by the kinetics of the solvent/non-solvent exchange. The process works at a certain temperature which influences the viscosity of the polymer solution. The temperature at the spinning nozzle and the temperature of the polymer solution and center fluid is 30 to 80° C. The viscosity determines the kinetics of the pore-forming process through the exchange of solvent with non-solvent. Subsequently, the membrane is preferably washed and dried.

By the selection of precipitation conditions, e. g. temperature and speed, the hydrophobic and hydrophilic polymers are “frozen” in such a way that a certain amount of hydrophilic end groups are located at the surface of the pores and create hydrophilic domains. The hydrophobic polymer builds other domains. A certain amount of hydrophilic domains at the pore surface area are needed to avoid adsorption of proteins. The size of the hydrophilic domains should preferably be within the range of 20 to 50 nm. In order to repel albumin from the membrane surface, the hydrophilic domains also need to be within a certain distance from each other. By the repulsion of albumin from the membrane surface, direct contact of albumin with the hydrophobic polymer, and consequently the absorption of albumin, are avoided.

The polymer solution used for preparing the membrane preferably comprises 10 to 20 wt.-% of hydrophobic polymer and 2 to 11 wt.-% of hydrophilic polymer. The center fluid generally comprises 45 to 60 wt.-% of precipitation medium, chosen from water, glycerol and other alcohols, and 40 to 55 wt.-% of solvent. In other words, the center fluid does not comprise any hydrophilic polymer.

In one embodiment, the polymer solution coming out through the outer slit openings is, on the outside of the precipitating fiber, exposed to a humid steam/air mixture. Preferably, the humid steam/air mixture has a temperature of at least 15° C., more preferably at least 30° C., and not more than 75° C., more preferably not more than 60° C.

Preferably, the relative humidity in the humid steam/air mixture is between 60 and 100%. Furthermore, the humid steam in the outer atmosphere surrounding the polymer solution emerging through the outer slit openings preferably includes a solvent. The solvent content in the humid steam/air mixture is preferably between 0.5 and 5.0 wt-%, related to the water content. The effect of the solvent in the temperature-controlled steam atmosphere is to control the speed of precipitation of the fibers. When less solvent is employed, the outer surface will obtain a denser surface, and when more solvent is used, the outer surface will have a more open structure. By controlling the amount of solvent within the temperature-controlled steam atmosphere surrounding the precipitating membrane, the amount and size of the pores on the outer surface of the membrane are controlled, i.e. the size of the openings of the pores is in the range of from 0.5 to 3 μm and the number of said pores is in the range of from 10,000 to 150,000 pores/mm². A fourth layer of a high cut-off dialysis membrane is preferably prepared by this method.

Before the extrusion, suitable additives may be added to the polymer solution. The additives are used to form a proper pore structure and optimize the membrane permeability, the hydraulic and diffusive permeability, and the sieving properties. In a preferred embodiment, the polymer solution contains 0.5 to 7.5 wt.-% of a suitable additive, preferably chosen from the group comprising water, glycerol and other alcohols.

The solvent may be chosen from the group comprising N-methylpyrrolidone (NMP), dimethyl acetamide (DMAC), dimethyl sulfoxide (DMSO) dimethyl formamide (DMF), butyrolactone and mixtures of said solvents.

Membranes which can also effectively be used according to the invention and methods for preparing them are described in EP 2 253 367 A1, the content of which is expressly included herein by reference.

As used herein, the term “sieving coefficient (S)” refers to the physical property of a membrane to exclude or pass molecules of a specific molecular weight. The sieving coefficient in whole blood, plasma or water can be determined according to standard EN 1283, 1996.

Put simply, the sieving coefficient of a membrane is determined by pumping a protein solution (bovine or human plasma) under defined conditions (Q_{B}, TMP and filtration rate) through a membrane bundle and determining the concentration of the protein in the feed, in the retentate and in the filtrate. If the concentration of the protein in the filtrate is zero, a sieving coefficient of 0% is obtained. If the concentration of the protein in the filtrate equals the concentration of the protein in the feed and the retentate, a sieving coefficient of 100% is obtained.

Methods for producing suitable membranes are disclosed, for example, in WO 2004/056460, incorporated herein by reference. Suitable high cut-off membranes which can be used according to the invention are available from Gambro Lundia AB under the trade name “HCO 1100®” or “Theralite®.” For example, the HCO 1100® dialyzer comprises a steam sterilized membrane based on polyethersulfone and polyvinylpyrrolidone with a wall thickness of 50 μm and an inner diameter of 215 μm. The in vivo albumin loss (H_{D}) of the HCO 1100® at Q_{D}=500 ml/min is about 1.5 g per hour of dialysis.

It will be readily apparent to one skilled in the art that various substitutions and modifications may be made to the invention disclosed herein without departing from the scope and spirit of the invention.

The present invention will now be illustrated by way of non-limiting examples of preferred embodiments in order to further facilitate the understanding of the invention.

### EXAMPLES

### Example 1

### Membrane Preparation

Two solutions are used for the formation of the membrane, the polymer solution consisting of hydrophobic and hydrophilic polymer components (21 wt-%) dissolved in N-methyl-pyrrolidone, and the center solution being a mixture of N-methyl-pyrrolidone and water. The polymer solution contains polyethersulfone (PES 14.0 wt-%) and polyvinylpyrrolidone (PVP 7.0 wt-%) as membrane building components. The solution further contains NMP (77.0 wt-%) and water (2.0 wt-%). The center solution contains water (53.0 wt-%) and NMP (47.0 wt-%).

During the membrane formation process polymer and center solution are brought in contact with a spinneret or jet and the membrane precipitates. A defined and constant temperature (58° C.) is used to support the process. The precipitated hollow fiber falls through a humidified shaft filled with steam (100% relative humidity, 54° C.) into a washing bath (20° C., ˜4 wt-% NMP). The membrane is further washed in two additional water baths (70° C.-90° C.) with counter current flow (250 l/h).

Membrane drying is performed online, wherein remaining water is removed.

### Example 2

### Preparation of Hand Bundles and Mini-Modules

The preparation of a membrane bundle after the spinning process is necessary to prepare the fiber bundle for following performance tests. The first process step is to cut the fiber bundles to a defined length of 23 cm. The next process step consists of melting the ends of the fibers. An optical control ensures that all fibers are well melted. Then, the ends of the fiber bundle are transferred into a potting cap. The potting cap is fixed mechanically and a potting tube is put over the potting caps. Then the fibers are potted with polyurethane. After the polyurethane has hardened, the potted membrane bundle is cut to a defined length and stored dry before it is used for the different performance tests.

Mini-modules [=fiber bundles in a housing] are prepared in a similar manner. The mini-modules ensure protection of the fibers and are used for steam-sterilization. The manufacturing of the mini-modules comprises the following specific steps:

The number of fibers required is calculated for an effective surface A of 360 cm2 according to equation (2)

A=π×dᵢ×1×n [cm²] (2)

wherein dᵢ is the inner diameter of fiber [cm], n represents the amount of fibers, and 1 represents the effective fiber length [cm]. The fiber bundle is cut to a defined length of 20 cm. The fiber bundle is transferred into the housing before the melting process. The mini-module is put into a vacuum drying oven over night before the potting process

### Example 3

### Dextran Sieving Coefficients

Dextran sieving coefficients are being determined according to the following method. The Sieving Coefficient (SC) is calculated according to the following equation:

$$SC = \frac{2 \times {C}_{F}}{{C}_{Bin} + {C}_{Bout}} [ \% ] ,$$

wherein C_{F} is the concentration of the solute in the filtrate, C_{Bin} is the concentration of a solute at the blood inlet side (feed) of the device under test, and C_{Bout} is the concentration of a solute at the blood outlet side (retentate) of the device under test. The determination of the sieving coefficients of a given device follows Scheme I below:

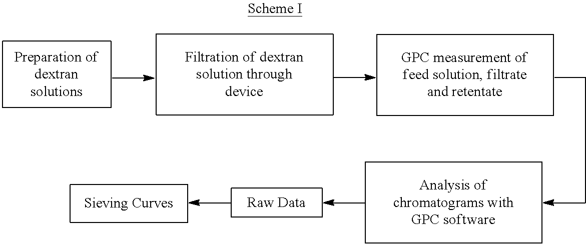

GPC, gel permeation chromatography, is a type of size exclusion chromatography that separates analytes on the basis of size. The technique is often used for the analysis of polymers. The calibration of the molecular weight versus the retention time is done with a number of dextran standard molecules. The analysis of the chromatograms is done with GPC software, e.g. PL Caliber™ GPC/SEC Software (Version 4.04) of Polymer Laboratories Ltd. or with Cirrus™ GPC Software (Version 3.2) of Polymer Laboratories Ltd.

GPC is performed with an eluent (mobile phase) comprising NaCl for analysis of Merck KGaA (CAS No. 7647-14-5), NaH₂PO₄*2H₂O for analysis of Merck KGaA (CAS No. 13472-35-0) and c(NaOH) 1 mol/l (1 N) TitriPUR® of Merck KGaA (Article No. 109137): 0.02M NaH₂PO₄*2H₂O+0.2 M NaCl, pH 7.0 with 1N NaOH. The column used is TSKgel® Size Exclusion (PW-Type) HPLC Guard Column (Supelco, Product No. 808033).

The dextran test materials used for determining the sieving coefficients of a given membrane are (1) 31388 dextran from Leuconostoc spp.—MW˜6,000 (Sigma); (2) D9260 dextran from Leuconostoc mesenteroides—MW˜9,500 (Sigma); (3) 31387 dextran from Leuconostoc spp.—MW ˜15,000-25,000 (Sigma); (4) D4626 dextran from Leuconostoc mesenteroides—MW˜15,000-30.000 (Sigma); (5) D1662 dextran from Leuconostoc mesenteroides—MW˜35,000-45,000 (Sigma); (6) 31389 dextran from Leuconostoc spp.—MW˜40,000 (Sigma); (7) 31390 dextran from Leuconostoc spp.—MW˜70,000 (Sigma); (8) 09184 dextran from Leuconostoc spp.—MW˜100,000 (Fluka); (9) D4876 dextran from Leuconostoc mesenteroides—average MW 150,000 (Sigma); (10) 31398 dextran from Leuconostoc mesenteroides—MW˜200,000 (Sigma); (11) 31392 dextran from Leuconostoc spp.—MW˜500,000 (Sigma); (12) 95771 Dextran from Leuconostoc spp.—MW˜2,000,000 (Sigma).

The dextrans used as standards are the following: (1) 31416 dextran from Leuconostoc mesenteroides—analytical standard, for GPC, MW 1,000 (Fluka, EC Number: 232-677-5); (2) 31417 dextran from Leuconostoc mesenteroides—analytical standard, for GPC, MW 5,000 (Fluka); (3) 31418 dextran from Leuconostoc mesenteroides—analytical standard, for GPC, MW 12,000 (Fluka); (4) 31419 dextran from Leuconostoc mesenteroides—analytical standard, for GPC, MW 25,000 (Fluka); (5) 31420 dextran from Leuconostoc mesenteroides—analytical standard, for GPC, MW 50,000 (Fluka); (6) 31421 dextran from Leuconostoc mesenteroides—analytical standard, for GPC, MW 80,000 (Fluka); (7) 31422 dextran from Leuconostoc mesenteroides—analytical standard, for GPC, MW 150,000 (Fluka); (8) 31423 dextran from Leuconostoc mesenteroides—analytical standard, for GPC, MW 270,000 (Fluka); (9) 31424 dextran from Leuconostoc mesenteroides—analytical standard, for GPC, MW 410,000 (Fluka); (10) 31425 dextran from Leuconostoc mesenteroides—analytical standard, for GPC, MW 670,000 (Fluka); (11) DXT1300K dextran standard, for GPC, MW 1,360,000.

For the HPLC a HP1090 A or Agilent 1200 device with RID (refractive index detector), such as the Agilent HP G1362A RID Detector is used. HPLC parameters are set to a flow of 1 ml/min and an injection volume of 150 μl.

All samples (feed solution, retentate, and filtrate) are filtered through a membrane filter (e.g. cellulose acetate circle OE 67 from Whatman, pore size 0.45 μm, thickness 115 μm, bubble point [bar] 4). The concentration of the dextran should be 0.1% of the dextran test material in water derived from a Millipore water system. Dextran standards are dissolved in water derived from a Millipore water system to a concentration of 0.1%. All samples should be measured on the same day.

The output of the HPLC is analysed and sieving coefficients are determined for given molecular weights. These values can be used for calculating the pore size distribution and average pore sizes of the tested membrane. The resulting sieving curves can be analyzed with regard to MWCO and MWRO (see also FIG. 5).

### Example 4

### Removal of Markers for Inflammation and EPO Resistance

Thirteen prevalent chronic hemodialysis patients were recruited into a study (Hutchison et al., J. Am. Soc. Nephrol. 19 (2008): High cut-off hemodialysis lowers inflammatory status in chronic dialysis patients). Patients received two weeks treatment using the Gambro HCO 1100™, followed by a two week wash-in period using a standardized high flux dialyser (Gambro Polyflux 170H). Kappa and lambda serum free light chains (22.5 kDa and 45 kDa respectively) were measured pre- and post-each dialysis session as markers of middle molecular weight proteins. Pro-inflammatory cytokines were measured using a 25-Plex AB Bead Kit (BioSource™).

Monocyte activation status as determined by expression of surface markers associated with cell trafficking and cell activation was assessed by flow cytometry. There were no clinical adverse events associated with high cut-off dialysis.

After the two weeks treatment period pre-dialysis serum free kappa and lambda were both reduced significantly, by 15% (0-28) and 19% (3-24) respectively (both P<0.01). Serum levels of pro-inflammatory cytokines, including IL-1b, IL-6 and TNF-alpha were less significantly increased during each hemodialysis sessions (all P<0.05). Expression of the monocyte cell surface proteins CCR2, CX3CR1, CD11b and CD163 were all down regulated (all P<0.01). Serum albumin was reduced by a median of 3 g/l (range 0-8), P<0.01.

### Example 5

### Improvement of ESA Responsiveness After Treatment Including High Cut-Off Dialyzers

A prospective, randomized, controlled, open parallel study is performed (“CIEPO”) wherein 24 hemodialysis patients with chronic inflammation are being treated with high cut-off hemodialysis using a Theralite® dialyzer or control high-flux dialyzers (Polyflux® Revaclear). The study details can be reviewed under http://clinicaltrial.gov/ using the ClinicalTrials.gov Identifier NCT01526798. Patients in the study group are being treated for 12 weeks with the high cut-off Theralite® dialyzer every second treatment (18 overall treatments with Theralite®, 18 overall treatments with conventional high-flux dialyzer). Patients in the control group are being treated with the conventional high-flux dialyzers at all treatments. The study period is followed by a follow-up period of 12 weeks, where all patients are treated with their conventional high-flux dialyzers.

During the first of three consecutive treatments in the first two and afterwards every four weeks pre-hemodialysis blood samples are analyzed for hepcidin, C-reactive protein (CRP), Interleukin 6 (IL-6), IL-10, Free Light Chains (FLC), urea, albumin, and routine blood values. Additionally to the pre-hemodialysis samples in the first two weeks, post-dialysis blood samples are analyzed in terms of hepcidin and IL-6, IL-10, and FLC. Routine blood values are measured every two weeks during study and follow-up period. IL-6, IL-10, FLC, CRP, and Hepcidin are measured with commercially available ELISA test kits. Serum and plasma are prepared according to standard laboratory procedures. The former is used for the determination of IL-6, IL-10, and FLC. The latter is used for the detection of hepcidin and CRP. The measurement of the FLC values is performed with a nephelometer. Routine blood values are determined using clinic routine laboratory tests.

It is one aim in the usage of the Theralite® dialyzer to also reduce the inflammatory level of the patients. The C-reactive Protein (CRP) is the most widely used parameter to describe the level of inflammation in dialysis patients and it is used in this study to measure the effect of the Theralite® dialyzer on the inflammatory status during the study period.

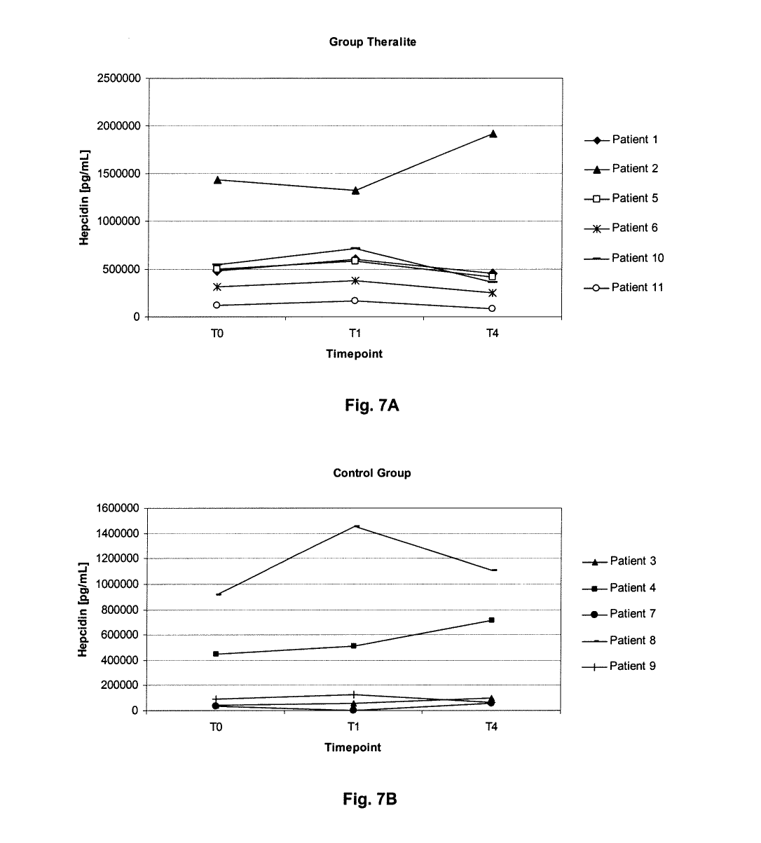

Hepcidin is thought to play a role as a key mediator of anemia of inflammation, However, due to its low molecular weight (2.8 kDa), clearance in this study should not differ much between the conventional high-flux and Theralite® membrane. Therefore, if Theralite treatment improves chronic inflammation hepcidin concentrations should decrease. In the present studies, hepcidin was measured with a commercially available ELISA test kit, “Hepcidin Elisa E91979Hu” from USCN Life Science, Inc. The evaluation of hepcidin concentration during the first three time points for the so far included patients (n=11) shows a tendency for an overall decrease of hepcidin in the study group (5 of 6 patients) while in the control group for 4 of 5 patients a tendency for an increase in the hepcidin concentration has been detected (FIG. 7A and ZB). In FIGS. 7A and 7B, T0 refers to the values of the respective patients before the start of the treatment. T1 refers to the values obtained after exactly one week of treatment, and T4 refers to the value after 5 weeks of treatment. Interestingly, the value T1 after the first week reflects the typical increase in hepcidin which is thought to reflect the onset of chronic inflammation due to the start of dialysis treatment. In the control group, except for one patient, hepcidin values show a tendency to increase as expected. In the group which is being treated with a Theralite® dialyzer according to the study plan, a decrease in hepcidin concentration can be seen with the exception of one patient.

Kappa and lambda FLC (MW 23 kDa and 45 kDa, respectively) are well described toxic middle molecule that cover the molecular weight range of 12 to 45 kDa which was expected to be significantly more accessible to elimination from blood by Theralite® in contrast to high-flux hemodialysis.

The level of the pro-inflammatory cytokine IL-6 (22-27 kDa), like the amount of IL-1, TNF-α, and CRP is elevated in CKD patients. Major causes seem to be the usage of bioincompatible membranes and non-sterile dialysate. Cytokine-induced inflammation was described to suppress bone marrow erythropoiesis in HD patients and is discussed to be a cause of anemia (Kanbay et al. Blood Purif 2010). IL-6 has a direct influence on the enhanced production of hepcidin during inflammation (Kotanko and Levin Seminars in Dialysis 2006).

IL-10 (18 kDa) seems to play an important role as an anti-inflammatory cytokine in the suppression of the inflammatory response in ESRD patients. The secretion of IL-10 occurs with a latency of a few hours to the release of pro-inflammatory factors to ensure a down-regulation of inflammatory reactions after a certain time. IL-10 production is stimulated via endotoxins and activated complement fragments which mediate bioincompatibility reactions during renal replacement therapy (Stenvikel et al. KI 2005).

To define a level of improvement in ESA responsiveness during study and follow-up period the EPO resistance index was calculated from the weekly ESA dose per kg body weight divided by haemoglobin (g/dL).

1. A method of treating anemia in a hemodialysis patient, comprising withdrawing and bypassing the blood from the patient in a continuous flow into contact with one face of a hemodialysis membrane, simultaneously passing dialysate solution in a continuous flow on an opposite face of the hemodialysis membrane to the side of the hemodialysis membrane in contact with the blood, the flow of the dialysate solution being countercurrent to the direction of flow of blood, and returning the blood into the patient, wherein the hemodialysis membrane has a molecular weight cut-off in water, based on dextran sieving coefficients, of between 90 and 200 kD and a molecular weight retention onset in water, based on dextran sieving coefficients, of between 10 and 20 kD, and a ΔMW of between 90 and 170 kD.

2. A method according to claim 1 further comprising reducing the amount of EPO which is administered per kg body weight per week to the hemodialysis patient by at least 10% relative to the EPO dose needed in the course of a hemodialysis treatment not according to the method of claim 1 to maintain a target hemoglobin value.

3. The method of claim 1, wherein the blood of the hemodialysis patient has a ferritin concentration of at least 100 ng/ml.

4. The method of claim 1, wherein the hemodialysis treatment is performed from 2 to 4 times per week for a period of from 2 to 6 hours.

5. The method of claim 1, wherein three haemodialysis treatments are performed per week, one for a period of 2 to 6 hours with the membrane according to claim 1, and two with a standard high-flux hemodialysis membrane.

6. The method of claim 1, wherein the hemodialysis membrane permits passage of substances having a molecular weight of up to 45 kD with a sieving coefficient measured in whole blood of between 0.1 and 1.0.

7. The method of claim 1, wherein the hemodialysis patient suffers from EPO hypo-responsiveness.

8. A dialysis membrane comprising at least one hydrophobic polymer and at least one hydrophilic polymer, wherein the membrane has a molecular weight cut-off in water, based on dextran sieving coefficients, of between 90 and 200 kD and a molecular weight retention onset in water, based on dextran sieving coefficients, of between 10 and 20 kD, and a ΔMW of between 90 and 170 kD, for treating anemia in hemodialysis patients.

9. The dialysis membrane of claim 8, wherein the membrane permits the passage of molecules having a molecular weight of up to 45 kDa with a sieving coefficient of from 0.1 to 1.0 in presence of whole blood.

10. The dialysis membrane of claim 8 for treating a hemodialyis patient whose blood has a ferritin concentration of at least 100 ng/ml.

11. The dialysis membrane of claim 8 having an average pore size of above 7 nm.

12. The dialysis membrane of claim 8 for performing haemodialysis treatment from 2 to 4 times per week for a period of from 2 to 6 hours each.

13. The dialysis membrane of claim 8, for performing one haemodialysis treatment on the patient per week for a period of 2 to 6 hours, two additional hemodialysis treatments per week being performed on the patient with a standard high-flux hemodialysis membrane.

14. The dialysis membrane of claim 8, for treating a hemodialysis patient who suffers from EPO hypo-responsiveness.

15. The method of claim 2 wherein the blood of the hemodialysis patient has a ferritin concentration of at least 100 ng/ml.

16. The method of claim 2 wherein the hemodialysis treatment is performed from 2 to 4 times per week for a period of from 2 to 6 hours.

17. The method of claim 3 wherein the hemodialysis treatment is performed from 2 to 4 times per week for a period of from 2 to 6 hours.

18. The dialysis membrane of claim 9 for treating anemia in a hemodialysis patient wherein the patient's blood has a ferritin concentration of at least 100 ng/ml.

19. The dialysis membrane of claim 9 for treating anemia in hemodialysis patients wherein the membrane has an average pore size of above 7 nm.

20. The dialysis membrane of claim 10 for treating anemia in hemodialysis patients wherein the membrane has an average pore size of above 7 nm.
